(19) United States
(12) Patent Application Publication
(10) Pub. No.: US 2025/0378688 A1
(43) Pub. Date: Dec. 11, 2025

(54) VEGETATION MANAGEMENT SYSTEM AND VEGETATION MANAGEMENT METHOD

(71) Applicant: HITACHI ENERGY LTD, Zürich (CH)

(72) Inventors: Yu ZHAO, Chiyoda-ku, Tokyo (JP); Tomonori YAMAMOTO, Chiyoda-ku, Tokyo (JP)

(21) Appl. No.: 18/876,348

(22) PCT Filed: Jun. 26, 2023
(86) PCT No.: PCT/EP2023/067234

§ 371 Date: Dec. 18, 2024

(30) Foreign Application Priority Data
Jun. 29, 2022 (JP) 2022-104298

(51) Int. Cl. G06V 20/10; G06T 7/00; G06V 10/62; G06V 10/764; G06V 10/77

(52) U.S. Cl. CPC G06V 20/188; G06T 7/0012; G06V 10/62; G06V 10/764; G06V 10/7715; G06V 20/176; G06T 2207/10032; G06T 2207/30004; G06T 2207/30184; G06T 2207/30188

(57) ABSTRACT

It is difficult to predict an influence of vegetation on a feature with high accuracy. Accordingly, in an embodiment, a vegetation management system, that manages an influence of vegetation on a predetermined feature, includes: an acquisition unit that acquires remote sensing image data of the vegetation; a classification unit that classifies, based on the remote sensing image data, a tree included in the vegetation in accordance with growth activity representing potential for future growth; a growth prediction unit that predicts growth of the tree based on a classification result obtained by the classification unit; a risk determination unit that determines risk of contact with the predetermined feature; and a visualization unit that outputs and visualizes a determination result obtained by the risk determination unit.

### TECHNICAL FIELD

The present invention relates to a vegetation management system and a vegetation management method.

### BACKGROUND ART

A conventional vegetation management system for maintaining a power facility predicts vegetation growth to prevent contact with a power line. In the prediction of vegetation growth, a detailed tree species is essential as basic information.

For estimation of the detailed tree species, there is a technique described in Japanese Patent Laying-Open No. 2019-144607 (Patent Literature 1). This Patent Literature includes a description such as “capturing an image of a ground surface to be analyzed via a satellite, generating a panchromatic image including a tree, automatically extracting the tree from the generated panchromatic image in accordance with an image feature, surrounding the tree with a circle, calculating a cooccurrence matrix in an inner region of the extracted circle, acquiring multispectral normalized data of a circle center, executing normalization processing, comparing the extracted tree with teacher data, creating a tree species estimation model using a multivariate analysis model, and estimating the species of the tree extracted from the panchromatic image of the ground surface to be analyzed using the analysis model.

Recently, efforts to automate a survey operation have been underway due to shortage of manpower. Many of the power transmission lines are installed in locations that are difficult for people to access, such as mountainous areas. Thus, the spotlight centers on a remote sensing technology to remotely monitor contact of a tree with a power distribution line or a power transmission line. As typical means of remote sensing, an artificial satellite or a drone is used. In addition, research and development of vegetation contact determination by three-dimensional measurement using a LIDAR sensor is also underway.

There is a technique described in Japanese Patent Laying-Open No. 2016-123369 (Patent Literature 1) relating to vegetation growth determination using remote sensing image data. Patent Literature 2 includes a description such as “a plant growth analysis system that analyzes growth of a plant on the basis of a remote sensing image, the plant growth analysis system including a feature value calculation unit that calculates a feature value of the growth of the plant on the basis of a plant growth model in which changes in the feature value are registered corresponding to time information of the plant indicating a time elapsed from a predetermined period and images corresponding to a plurality of growing locations of the plant, the images being part of the remote sensing image, a growth difference correction unit that refers to the plant growth model and corrects feature values of the plurality of growing locations to feature values corresponding to reference time information, and an image generation unit that generates a new image so that the images corresponding to the plurality of growing locations as part of the remote sensing image show the corrected feature values.”

### CITATION LIST

[Patent Literature 1] Japanese Patent Laying-Open No. 2019-144607

[Patent Literature 2] Japanese Patent Laying-Open No. 2016-123369

### SUMMARY OF INVENTION

### Problems to be Solved by the Invention

In conventional power facility maintenance work, a worker periodically conducts a field survey along a route of a power facility (e.g., a power distribution line or a power transmission line), and performs work such as removal of tree branches or application of herbicides in areas where problems may occur. In the tree survey, a worker with expertise in trees goes to the site and checks the trees one by one to identify the tree species and predicts future growth risk. If a tree considered to have a risk is found, the worker notifies a tree-felling company of it. However, identification of tree specifies is extremely difficult and often difficult even for specialists.

Methods using drones and helicopters are also beginning to be introduced. In these methods, a platform for handling large amounts of, different types of, and time-series geographical information data is developed, and operational support is performed through operation and visualization. However, if the photographing area becomes wide or the frequency of photographing increases, the cost extremely increases.

There is also a method that generates a three-dimensional tree map by three-dimensional restoration from data obtained by a LiDAR sensor. In this vegetation analysis using the three-dimensional map, it is difficult to perform highly accurate analysis of vegetation classification and growth prediction due to the characteristics of data. In addition, because the correct data reliability is not high due to difficulty in distinguishing vegetation, vegetation classification modeling itself is difficult.

In view of the above, an important object is how to predict the influence of vegetation on a power facility with high accuracy. Such an object arises not only in a power facility, but also in another feature in the same manner. Thus, it is an object to predict the influence of vegetation on a feature with high accuracy.

### Means for Solving the Problems

In order to achieve the above object, one of the representative vegetation management systems of the present invention is a vegetation management system that manages an influence of vegetation on a predetermined feature, the vegetation management system including: an acquisition unit that acquires remote sensing image data of the vegetation; a classification unit that classifies, based on the remote sensing image data, a tree included in the vegetation in accordance with growth activity representing potential for future growth; a growth prediction unit that predicts growth of the tree based on a classification result obtained by the classification unit; a risk determination unit that determines risk of contact with the predetermined feature; and a visualization unit that outputs and visualizes a determination result obtained by the risk determination unit.

Further, one of the representative vegetation management methods of the present invention is a vegetation management method performed by a vegetation management system that manages an influence of vegetation on a predetermined feature, the method including: by the vegetation management system, acquiring remote sensing image data of the vegetation; classifying, based on the remote sensing image data, a tree included in the vegetation in accordance with growth activity representing potential for future growth; predicting growth of the tree based on a classification result obtained by the classifying; determining risk of contact with the predetermined feature; and outputting and visualizing a determination result obtained by the determining risk.

### Advantageous Effects of Invention

According to the present invention, the influence of vegetation on a feature can be predicted with high accuracy. Problems, configurations, and effects other than those described above will become apparent from the following description of an embodiment.

### BRIEF DESCRIPTION OF DRAWINGS

FIG. 1 is a schematic diagram illustrating an example of the configuration of a vegetation management system for power facility maintenance in a first embodiment of the present invention.

FIG. 2 is a configuration diagram illustrating the hardware configuration of the vegetation management system in the first embodiment.

FIG. 3 is a flowchart for explaining processing in the entire system 100 in the first embodiment.

FIG. 4 is a flowchart for explaining processing in a withered tree extraction unit in the first embodiment.

FIG. 5 is a flowchart for explaining processing in a tree height estimation unit in the first embodiment.

FIG. 6 is a flowchart for explaining processing in a tree crown extraction unit in the first embodiment.

FIG. 7 is a flowchart for explaining processing in a time-series analysis unit in the first embodiment.

FIG. 8 is a flowchart for explaining processing in a vegetation classification unit in the first embodiment.

FIG. 9 is a flowchart for explaining processing in a growth prediction unit in the first embodiment.

FIG. 10 is a flowchart for explaining processing in a risk determination unit in the first embodiment.

FIG. 11 is a schematic diagram illustrating processing in the withered tree extraction unit in the first embodiment.

FIG. 12 is a schematic diagram illustrating processing in the tree height estimation unit in the first embodiment.

FIG. 13 is a schematic diagram illustrating processing in the tree crown extraction unit in the first embodiment.

FIG. 14 is a schematic diagram illustrating processing in the vegetation classification unit in the first embodiment.

FIG. 15 is a schematic diagram illustrating intrusion risk processing in the risk determination unit in the first embodiment.

FIG. 16 is a schematic diagram illustrating lodging risk processing in the risk determination unit in the first embodiment.

FIG. 17 is a schematic diagram illustrating fly-out risk processing in the risk determination unit in the first embodiment.

FIG. 18 is a schematic diagram illustrating a database in the first embodiment.

FIG. 19 is an example of a GUI schematic diagram illustrating visualization and a maintenance instruction in the first embodiment.

FIG. 20 is an example of a schematic diagram illustrating the maintenance instruction in the first embodiment.

FIG. 21 is a flowchart for explaining processing in a maintenance instruction unit in the first embodiment.

### MODE FOR CARRYING OUT THE INVENTION

Hereinbelow, an embodiment will be described with reference to the drawings.

### First Embodiment

Hereinbelow, a first embodiment to which a vegetation management system and method for power facility maintenance of the present invention is applied will be described.

First, an overview will be given. A vegetation management system disclosed in the embodiment generates a height map of a vegetation area using measurement information such as remote sensing information, geographical information, and environment information, extracts a tree crown from the height map, performs vegetation classification, performs growth prediction on the basis of a result of the classification, and determines contact risk and damage risk of a power facility.

Classifying the detailed species of a tree in the conventional manner for the vegetation growth prediction causes a bottleneck. The conventional classification uses the order, family, or the like to which the tree belongs in botany. Thus, determination is difficult.

The disclosed system provides a new tree classification method to solve the conventional bottleneck. Specifically, the disclosed system performs classification by actual tree activity (the degree of future growth potential). The embodiment shows an example in which trees are classified by activity into “a withered tree (no activity)”, “a slow growing tree (low activity)”, “a fast growing tree (medium activity)”, and “a special growing tree (high activity)”. In the classification by tree activity, estimation is performed by analyzing remote sensing data and introducing a machine learning model.

Also, in the present invention, different criteria are used to predict growth and determine contact with a power line depending on activity.

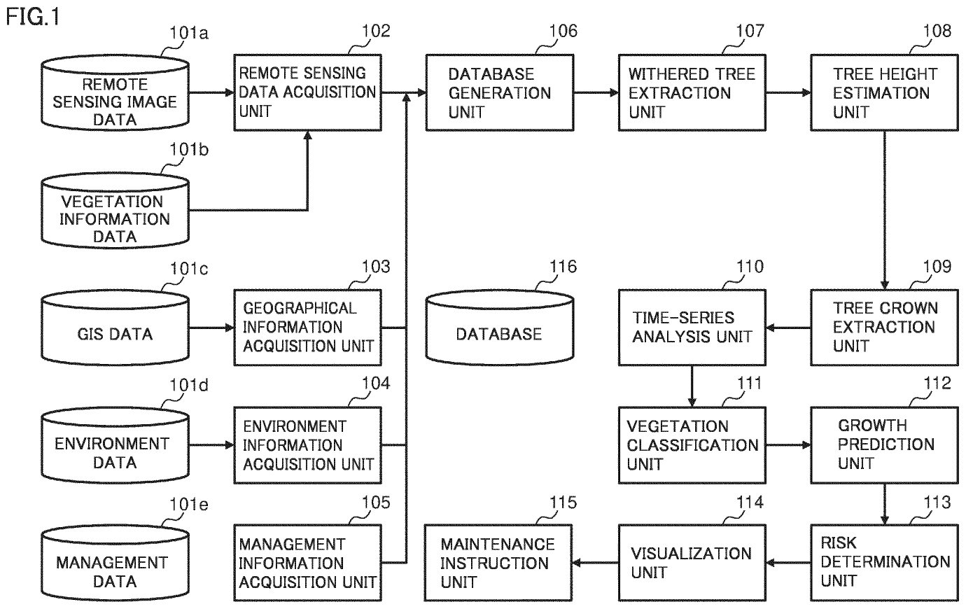

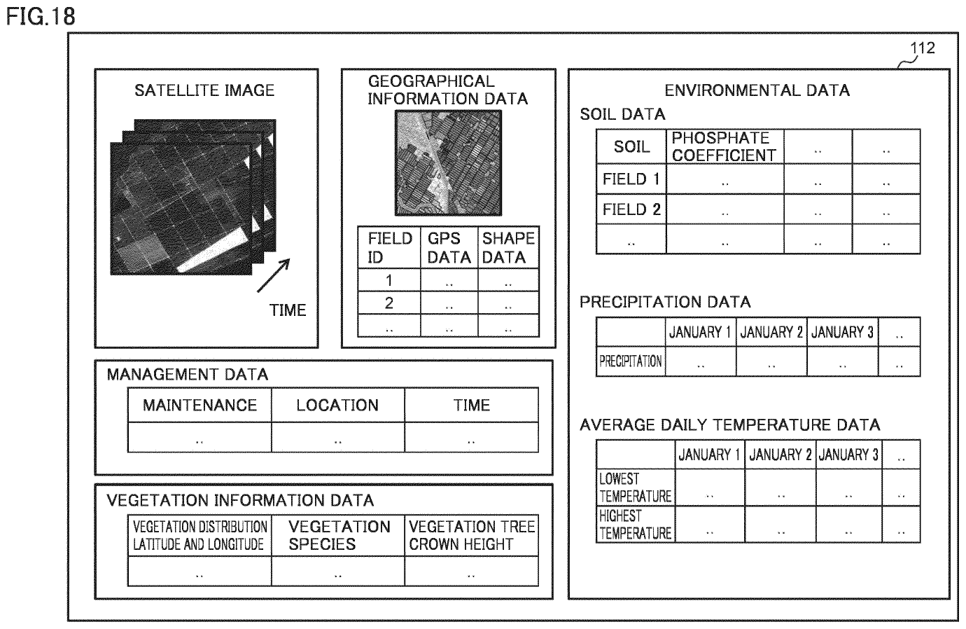

FIG. 1 is a block diagram illustrating the configuration of a vegetation management system 100 for power facility maintenance in the first embodiment. Vegetation management system 100 for power facility maintenance includes a plurality of different data items 101 (remote sensing image data 101a, vegetation information data 101b, geographical information data 101c, environment information data 101d, and management information data 101e), a remote sensing data acquisition unit 102, a geographical information acquisition unit 103, an environment information acquisition unit 104, a management information acquisition unit 105, a database generation unit 106, a withered tree extraction unit 107, a tree height estimation unit 108, a tree crown extraction unit 109, a time-series analysis unit 110, a vegetation classification unit 111, and a growth prediction unit 112. Vegetation management system 100 acquires time-series remote sensing image data, vegetation information data, geographical information data, and environmental data for observing vegetation and provides a database 116 with these data items. Note that the remote sensing image data, the vegetation information, the geographical information data, and the environmental data will be described with reference to FIG. 1, and the database will be described with reference to FIG. 18.

Vegetation management system 100 provides data managed in database 116 to a risk determination unit 113 to determine the risk of contact between a power facility and vegetation and causes a visualization unit 114 to visualize the contact risk. Also, vegetation management system 100 provides information stored in risk determination unit 113 and visualization unit 114 to a maintenance instruction unit 115 and uses the information for facility maintenance support.

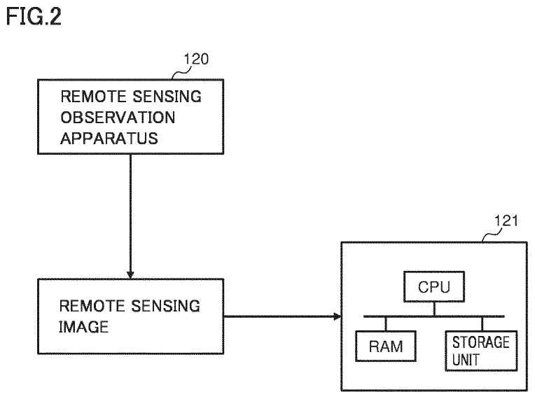

FIG. 2 illustrates the overall hardware state of the vegetation management system described above. A remote sensing observation apparatus 120 captures the remote sensing image. Remote sensing observation apparatus 120 is not limited to any particular type of apparatus and may be, for example, an observation satellite or a photographing apparatus of an aircraft. In the present embodiment, a satellite image captured by an observation satellite will be described. A computer system 121 acquires the remote sensing image data and operates as vegetation management system 100 in FIG. 1. Computer system 121 has a typical hardware configuration including a CPU, a RAM, a storage unit, and the like.

Return to FIG. 1 to continue the explanation. Remote sensing image data 101a is image data obtained from a remote sensing sensor and any aerial photograph. Note that, while time-series low-resolution and high-resolution remote sensing images are described as different remote sensing images in the present embodiment, the type of data is not limited to any particular type. Also, time-series images in the same remote sensing image may be used. Note that the difference in resolution is based on relative comparison.

Vegetation information data 101b is vegetation distribution information, spectral information, species information, tree crown height information, or the like, and the type of data is not limited to any particular type.

The vegetation distribution information is information on latitude and longitude, a distribution shape position, or the like.

The spectral information is spectral or spatial information (color or shape) obtained by an optical sensor. In particular, the optical sensor is a passive sensor that obtains information using light from an object to be observed. As with a camera, the optical sensor basically has the same structure and function as an eye (naked eye), and an optical system such as a lens (lens) collects light from the object and forms an image on a detection system (retina). Especially for the spectrum (color), while the eye captures only visible light, the optical sensor can detect light over a wide range of wavelengths from visible light to infrared rays. This makes it possible to obtain many pieces of useful information such as identification of minerals and vegetation that cannot be determined by the eye, the temperature of a ground surface, land usage, and water and plankton resources in oceans, lakes and mashes. These can also be obtained as two-dimensional images over a wide range. The vegetation species data and the tree height data are data items obtained through field sampling and actual measurements.

Geographical information data 101c is data essential for sharing local data and satellite data, such as polygon data and position information data. Examples of environment information data 101d include soil data, meteorological data, elevation data, gradient data, and many pieces of other data. Examples of the meteorological data include various pieces of data such as AMeDAS data, MODIS surface temperature satellite data, and weather bureau data, but the type of data is not limited to any particular type. Management information data 101e is operational data such as power company operation and maintenance memos, logs, history, and the like. Other data may be used.

Remote sensing data acquisition unit 102, geographical information acquisition unit 103, environment information acquisition unit 104, management information acquisition unit 105, database generation unit 106, withered tree extraction unit 107, tree height estimation unit 108, tree crown extraction unit 109, time-series analysis unit 110, vegetation classification unit 111, growth prediction unit 112, risk determination unit 113, and visualization unit 114 are implemented as a combination of multiple CPUs and RAMs divided according to roles to perform various arithmetic processes. A hard disk, a USB memory, or the like as an external storage apparatus is employed in each unit described above.

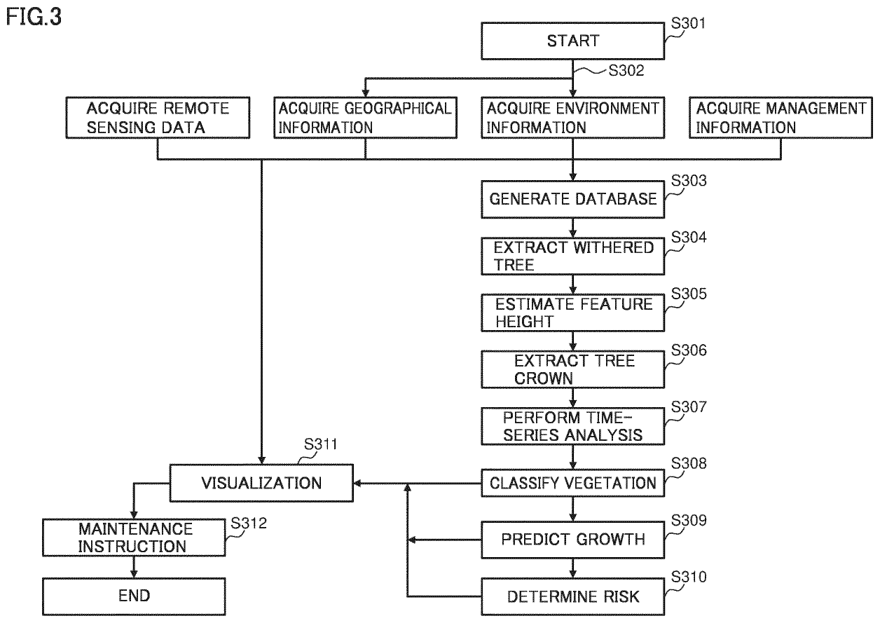

FIG. 3 is a flowchart for explaining an example of processing in the entire vegetation management system 100 for power facility maintenance in the first embodiment. First, in S302, vegetation management system 100 inputs remote sensing image data and vegetation information data acquired as the different data items to remote sensing data acquisition unit 102. Geographical information data is input to geographical information acquisition unit 103. Environment information data is input to environment information acquisition unit 104. In the present embodiment, the environment information mainly includes meteorological data, but the environment information may include other data. The meteorological data includes an air temperature, the amount of rainfall, and sunlight irradiation, but the meteorological data may include other data. Management information data is input to management information acquisition unit 105. In the present embodiment, the management information data includes a monitoring log, a tree-felling log, a maintenance location, and a time history, but the management information data may include other data.

In S303, vegetation management system 100 provides all the input data items to database generation unit 106. The geographical information data includes position information and shape information, and masking of a location of interest is performed on the remote sensing data on the basis of the position and shape. A masking part is extracted, remote sensing data and environmental data of the part are generated by the database generation unit, and the data is provided to database 112. The management information data is provided to database 116.

In S304, vegetation management system 100 extracts a withered tree area from remote sensing image data, vegetation geographical information data, and vegetation information data stored in database 116 and provides a map of the extracted withered tree area to database 116. A method of the extraction will be described in the description of withered tree extraction unit 107.

In S305, using geographical information data of classified vegetation, remote sensing image data showing a digital surface model, multi-band satellite image data, meteorological data, elevation model data, and the like stored in database 116, vegetation management system 100 removes the withered tree area map, which is a result of the extraction by withered tree extraction unit 107, stored in database 116, constructs a model for estimating a tree crown height for an vegetation area, and provides, together with the model, a crown height map for the vegetation area to database 116. Details of methods of the model construction and the height estimation will be described further below.

In S306, using the tree crown height map of the vegetation area stored in database 116, vegetation management system 100 extracts a tree crown of vegetation and provides geographical information data of a result of the tree crown to database 116. Details of a method of the extraction will be described further below.

In S307, using results of multiple executions of processes of S305 and S306 on a time-series basis, vegetation management system 100 calculates a tree crown change and a tree height change and provides a result of the calculation to database 116. Details of a method of the time-series analysis will be described further below.

In S308, using the tree crown change and the tree height change stored in database 116, vegetation management system 100 performs tree classification based on tree growth activity and provides geographical information data of a result of the classification to database 116. Details of a method of the classification will be described further below.

In S309, using tree species information stored in database 116, vegetation management system 100 constructs different growth prediction models on a species-by-species basis and predicts future growth, and provides the predicted future tree height and tree crown size to database 116. Details of a method of the growth prediction on a species-by-species basis will be described further below.

In S310, using geographical information data of the predicted vegetation growth result, that is, the predicted tree crown size and tree height data, and power facility geographical information data, vegetation management system 100 evaluates a two-dimensional positional relationship between time-series changes in a vegetation broad range and the power facility and evaluates a three-dimensional positional relationship between time-series changes in a vegetation tree height and the power facility with physical models of intrusion risk, fly-out risk, and lodging risk. Vegetation management system 100 determines power facility risk for each classification by tree growth activity taking results of the evaluations into consideration and provides a result of the determination to database 116. Details of a method of risk determination model construction and calculation will be descried further below.

In S311, using the geographical information data of the predicted vegetation growth result, that is, the predicted tree crown size and tree height data, the power facility geographical information data, and geographical information data for the risk determination result, vegetation management system 100 performs mapping on the remote sensing image. Two-dimensional or three-dimensional display is performed at a specific time or at specified time intervals using the time-series changes in vegetation growth and the risk determination result. Details of visualization will be described further below.

In S312, vegetation management system 100 waits for a result of the analysis and presents a maintenance instruction using the management information data stored in database 116.

All data items are stored in the database. The data items are illustrated in FIG. 18.

Remote sensing data acquisition unit 102 acquires remote sensing image data 101a, receives input of vegetation information data 101b, and provides these data items to database generation unit 106.

Geographical information acquisition unit 103 acquires geographical information data 101c and provides the acquired data to database generation unit 106.

Environment information acquisition unit 104 acquires environment information data 101d and provides the acquired data to database generation unit 106.

Management information acquisition unit 105 acquires management information data 101e and provides the acquired data to database generation unit 106.

Then, database generation unit 106 maps the remote sensing image data, the vegetation information data, the environmental data, and the geographical information data stored in database 116 together.

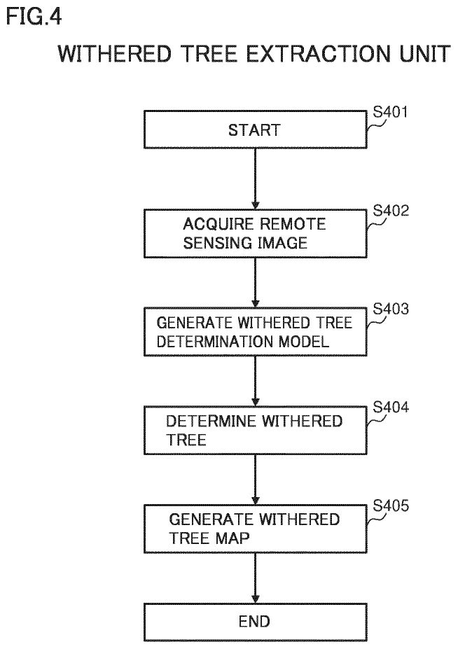

Withered tree extraction unit 107 extracts a withered tree area using the mapping result generated by database generation unit 106. FIG. 4 is a flowchart for explaining processing in withered tree extraction unit 107 in the first embodiment.

In S402, withered tree extraction unit 107 inputs the mapping data of the remote sensing image and the geographical information generated by database generation unit 106.

In S403, using the remote sensing mapping data, the vegetation information data, and the environmental data, withered tree extraction unit 107 generates a model for determining an area corresponding to a withered tree in a mapping range of the remote sensing image data. As an example of the withered tree area determination model, using a machine learning method, pixel-based spectral information of a target pixel is extracted, and texture information in a window range set within a certain range around the target pixel is calculated as a feature value. The spectral information includes, for example, R, G, B, or infrared rays. Using different remote sensing images result in different pieces of spectral information. The texture information indicates, for example, texture, feel, a pattern of the surface of an object. Texture analysis quantifies, as a function of image spatial variation in pixel intensity, general texture such as rough, smooth, silky luster, or bumpy. As an example of the calculation method, a GLCM matrix is first calculated, and a feature value such as entropy or energy is calculated using the calculated GLCM matrix. The texture information is not limited to GLCM, and another calculation method may be used. In this manner, it is possible to learn three categories of a withered tree, a healthy tree, and grass and generate models using the feature value of texture information within the certain range around the target pixel. Note that classification categories are not limited to the three categories and may be the withered tree and another classification category.

In S404, withered tree extraction unit 107 extracts a withered tree area using the generated withered tree extraction model and stores the extracted withered tree area in database 116.

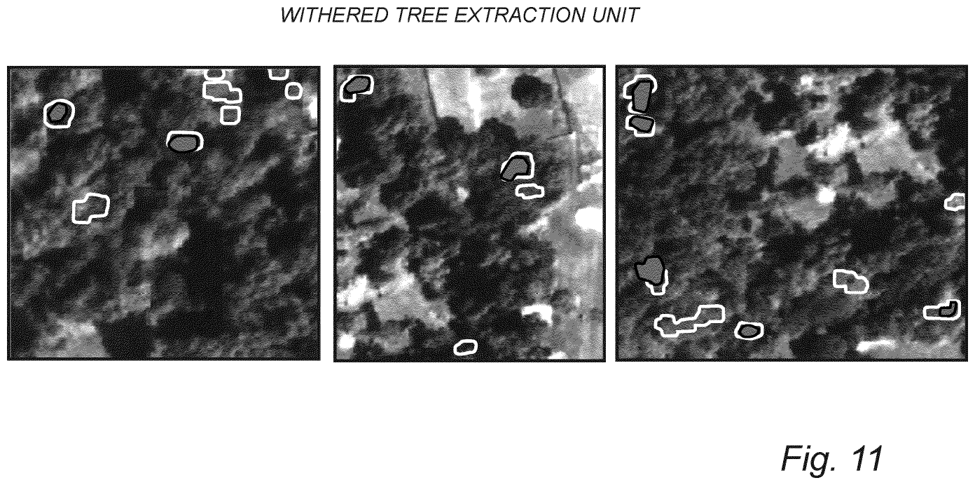

In S405, withered tree extraction unit 107 converts the withered tree area stored in database 116 into geographical information data and provides the geographical information data to database 116. FIG. 11 is a schematic diagram illustrating a result of the withered tree area. In FIG. 11, the withered tree area is enclosed in a white frame on a satellite image. FIG. 11 also illustrates an area enclosed in a black frame. The area enclosed in the black frame is a withered tree area added by, for example, an operator to the generated image.

Tree height estimation unit 108 excludes the withered tree area using the generated withered tree area geographical information data, estimates a tree crown height in the corresponding vegetation area using remote sensing data showing the digital surface model and the multi-band satellite image stored in database 116, and provides, together with the estimated height, a tree crown estimation model to database 116.

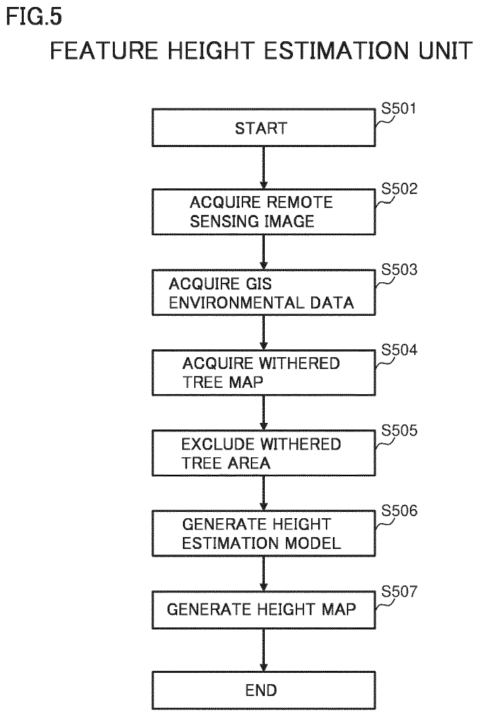

FIG. 5 is a flowchart for explaining processing in the tree height estimation unit in the first embodiment. In S502, tree height estimation unit 108 inputs a remote sensing data multi-band satellite image representing the digital surface model stored in database 116.

In S503, tree height estimation unit 108 inputs the generated geographical information data, environment information data, and vegetation information data.

In S504, tree height estimation unit 108 inputs the generated withered tree area geographical information data.

In S505, tree height estimation unit 108 excludes the withered tree area from the geographical information data of the concerned withered tree area.

In S506, tree height estimation unit 108 generates a tree crown height estimation model using mapping of the generated remote sensing image data, geographical information data, and environmental data. As an example of a method of the estimation, a Random forest machine learning model may be used, and the tree crown height estimation model may be constructed with a value of the digital surface model as an objective variable and spectral data, meteorological data, elevation data, vegetation data, and the like as explanatory variables. Tree height estimation unit 108 estimates the tree crown height using the constructed tree height estimation model. A method of the estimation may be another method.

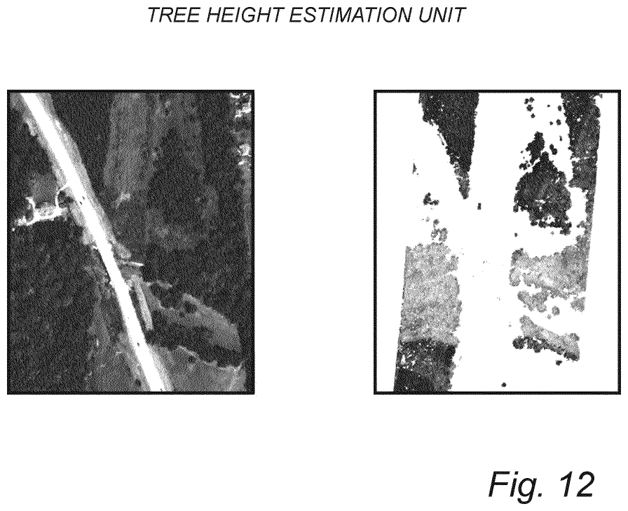

In S507, tree height estimation unit 108 generates a tree height map using the generated tree crown height estimation model and stores the tree height map in database 116. FIG. 12 is a schematic diagram illustrating tree height estimation processing. A mapping image showing the tree height is generated from a normal satellite image, and changes in tree height are shown by color variations from white to black.

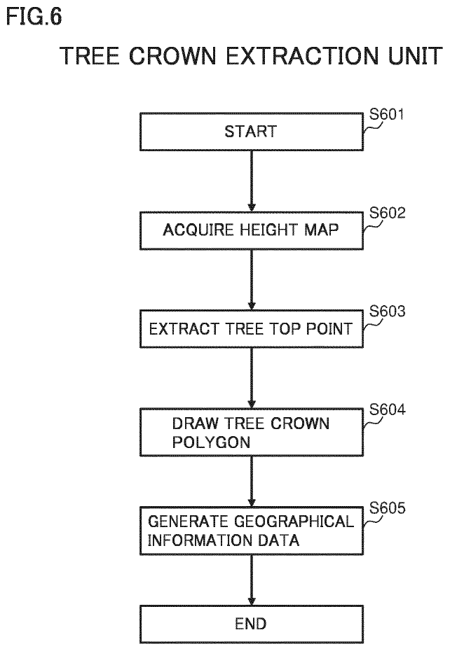

Tree crown extraction unit 109 extracts a tree crown of a tree using the tree height map within the vegetation area stored in database 116. FIG. 6 is a flowchart for explaining processing in the tree crown extraction unit in the first embodiment.

In S602, tree crown extraction unit 109 inputs the tree height map within the vegetation area stored in database 116.

In S603, tree crown extraction unit 109 detects a tree top point using the tree height map in the vegetation area. Tree crown extraction unit 109 converts the detected top point into point geographical information data and stores the point geographical information data in database 116. As an example of a method for detecting the tree top point, the tree height map may be searched pixel by pixel, and the highest pixel point within a window range having a certain size may be detected as the tree top point. The top point detecting method may be another method. The size of the search window is previously set.

In S604, tree crown extraction unit 109 draws a tree crown polygon using the tree top point geographical information data stored in database 116.

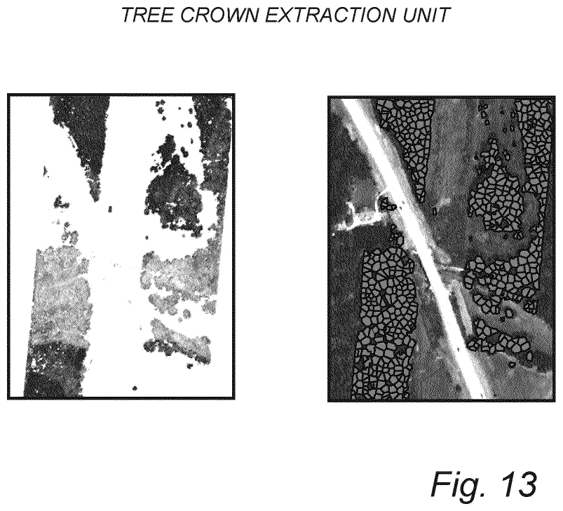

In S605, tree crown extraction unit 109 converts the drawn polygon into geographical information data and provides the geographical information data to database 116. FIG. 13 is a schematic diagram illustrating tree crown extraction processing. A fine tree crown polygon is extracted from the tree height map, converted into a shape file, and mapped.

Time-series analysis unit 110 analyzes time-series remote sensing image data generated by database generation unit 106 and calculates a tree crown size change and a height change in the vegetation using the tree crown extraction method and the vegetation area height estimation method stored in database 116.

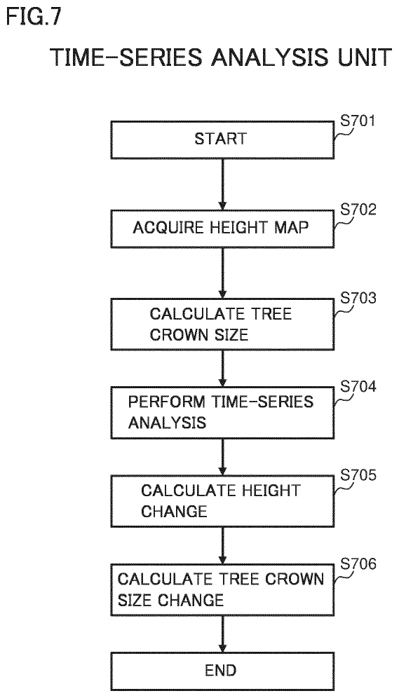

FIG. 7 is a flowchart for explaining processing in the time-series analysis unit in the first embodiment.

In S702, time-series analysis unit 110 acquires a height at each time point in the time series.

In S703, time-series analysis unit 110 calculates a tree crown size at each time point in the time series.

In S704, time-series analysis unit 110 performs time-series analysis on the calculated time-series tree crown size data and time-series height data.

In S705, time-series analysis unit 110 calculates a height change in the concerned tree and provides the height change to database 116.

In S706, time-series analysis unit 110 calculates a tree crown size change in the concerned tree and provides the tree crown size change to database 116.

Vegetation classification unit 111 performs vegetation classification by growth activity representing potential for future growth using the crown size change rate and the height change rate of the concerned tree stored in database 116.

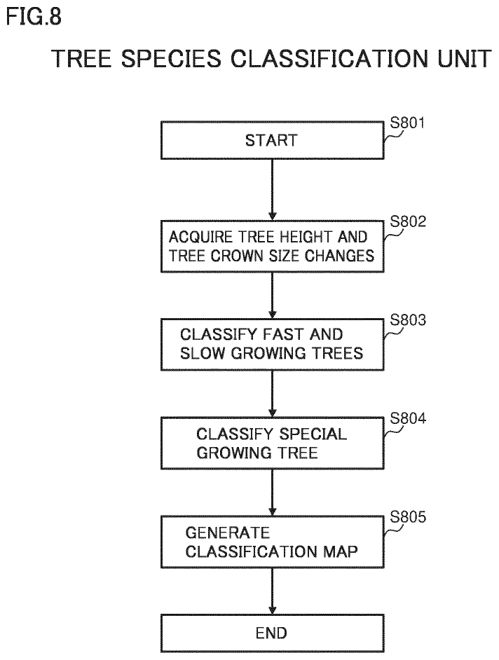

FIG. 8 is a flowchart for explaining processing in the vegetation classification unit in the first embodiment.

In S802, vegetation classification unit 111 inputs the tree crown size change rate and the height change rate of the concerned tree stored in database 116.

In S803, vegetation classification unit 111 determines a tree growth potential using the input tree crown size change rate and height change rate of the concerned tree. An example of a method for determining the tree growth potential will be described. When the calculated tree crown size change rate and height change rate of the tree tend to decrease with time, the tree is highly likely to enter into a period of maturity and thus classified into the slow growing tree. On the other hand, when the calculated tree crown size change rate and height change rate of the tree tend to increase with time, the tree is highly likely young and thus classified into the fast growing tree. The method for the classification into the fast growth and the slow growth may be another method.

In S804, vegetation classification unit 111 extracts a special growing tree area using a tree-felling record and tree-felling location information data stored in a management database.

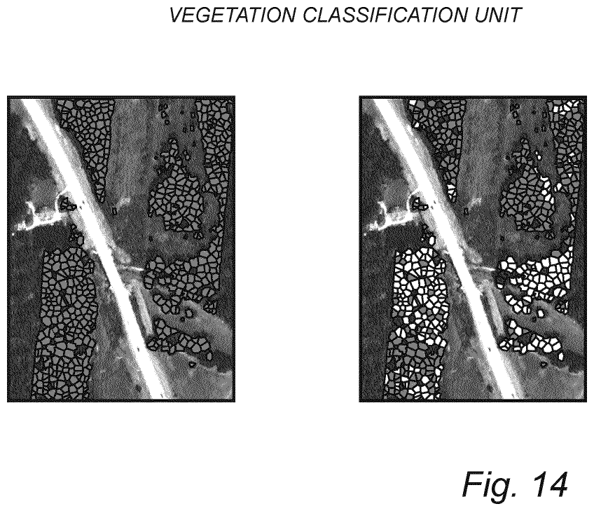

In S805, using the withered tree area extracted by withered tree extraction unit 107, the special growing tree area extracted in S804, the fast growing tree and slow growing tree areas classified in S803, vegetation classification unit 111 generates a result of the vegetation classification by growth activity and provides the vegetation classification result to database 116. FIG. 14 is a schematic diagram illustrating vegetation classification processing. Mapping is performed in polygon format with different colors for the respective species of trees.

Growth prediction unit 112 predicts future growth in different methods for the respective specifies using a vegetation classification map stored in database 116 and the remote sensing image data, the environmental data, and the vegetation information data generated by database generation unit 106 and provides a future tree crown size and a future height to database 116.

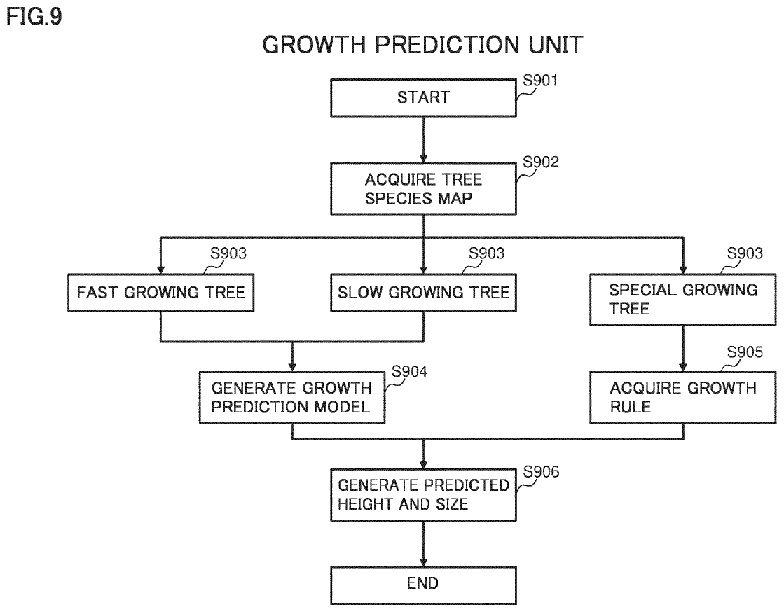

FIG. 9 is a flowchart for explaining growth prediction processing in the first embodiment.

In S902, growth prediction unit 112 inputs the vegetation classification map stored in database 116.

In S903, growth prediction unit 112 introduces different growth prediction methods for different vegetation categories. Growth prediction unit 112 refers to the vegetation classification map stored in database 116, calculates future growth of a tree classified as the withered tree as zero because the tree has no growth activity, and provides the calculation result to database 116.

Growth prediction unit 112 generates a growth prediction model in S904 and predicts future growth for trees classified as the fast growing tree and the slow growing tree. As an example of the growth prediction model, future growth is estimated using deep learning. Examples of the feature value include a time-series analyzed height map, spectral information calculated from remote sensing image data, and a vegetation index calculated from remote sensing image data, for example, an NDVI. These are examples, and any feature value can be used. Examples of the feature value may also include maps of meteorological data, environmental data, and topographic data generated by database generation unit 106. The objective variables are the tree height and the tree crown size after growth. For these data items, ground truth data is obtained through field surveys and the model is learned. The future height and tree crown size can be estimated from the time-series analyzed height map and can further be corrected by deep learning. As an example of the prediction model, a recurrent neural network (RNN) is used, and time-series changes are predicted. A wide-range change at time t3 or later is predicted from satellite images at time t1 and time t2 in the past, a tree height map is generated from a wide-range map at time t3 or later, and the tree height change and the tree crown size are predicted. However, this is not a limitation, and another model may be used.

Growth prediction unit 112 inputs a growth rule stored in the management database and simulates future growth by a prediction method in S905 for a tree classified as the special growing tree. In S906, growth prediction unit 112 converts the predicted future tree crown size and height into data in a geographical information data format and provides the converted data to database 116.

Risk determination unit 113 determines contact risk taking into consideration the positional relationship with the power facility, using the predicted tree growth state and the predicted tree crown size change and tree height change, and provides the contact risk to database 116. Examples of the contact risk include different physical models. Examples of the contact risk include intrusion risk, lodging risk, and fly-out risk. Risk determination unit 113 applies different physical models to different species of trees classified by the vegetation classification unit.

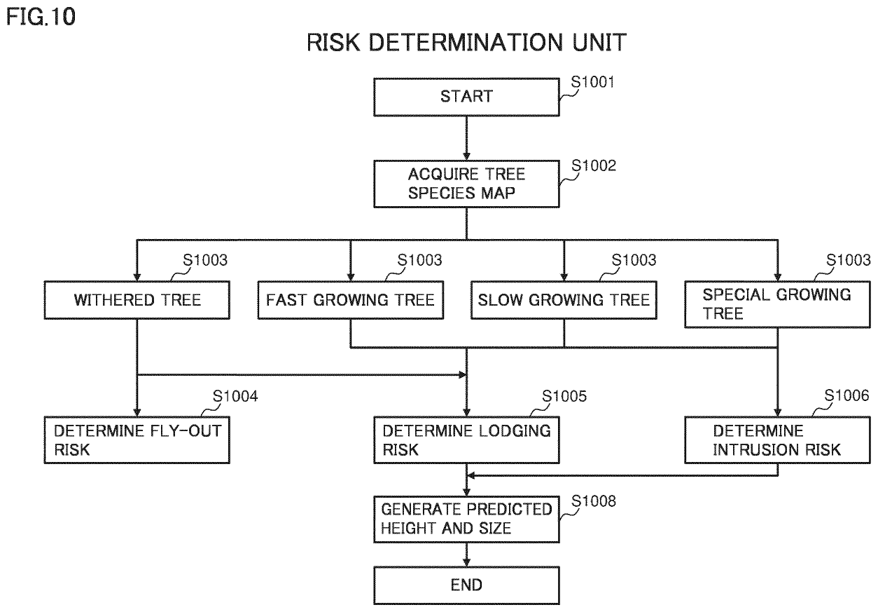

FIG. 10 is a flowchart for explaining processing in the risk determination unit in the first embodiment.

In S1002, risk determination unit 113 inputs the generated vegetation classification map and the predicted tree crown size change and height change at a specific time.

In S1003, risk determination unit 113 performs risk determination on different species of trees using different physical models. Risk determination unit 113 refers to the vegetation classification map stored in database 116 and performs determination of fly-out risk and lodging risk on a tree classified as the withered tree. Also, risk determination unit 113 performs determination of intrusion risk and lodging risk on trees classified as the fast growing tree and the slow growing tree. Also, risk determination unit 113 performs determination of intrusion risk on a tree classified as the special growing tree.

The fly-out risk, the intrusion risk, and the lodging risk will be described in S1004, S1006, and S1005, respectively.

In S1004, risk determination unit 113 determines the fly-out risk from the predicted tree crown size and height at the specific time. The fly-out risk is the risk of a withered tree flying in and coming into contact with the power facility due to strong wind or the like. The fly-out risk determination relates to the intensity and direction of wind, and, in the case of a mountain, the orientation and slope of the mountain. A withered tree fly-out simulation is performed using these parameters. When the withered tree is highly likely to come into contact with the power facility, highlighting is performed for visualization. Risk determination unit 113 converts the detected area having high risk into geographical information data and provides the geographical information data to database 116.

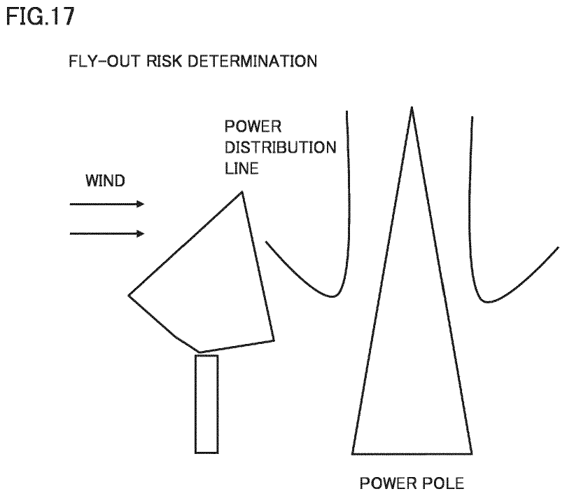

FIG. 17 is a schematic diagram illustrating fly-out risk processing in the risk determination unit in the first embodiment.

In S1005, risk determination unit 113 determines the lodging risk from the predicted tree crown size and height at the specific time. In this determination, a location with high contact possibility in the case of lodging is estimated using the predicted tree crown size and height changes and the positional relationship with a power distribution line or a power transmission line. As an example of a method of the estimation, the lodging risk is determined taking into consideration the height of the tree and an area occupied by the lodged tree, using a three-dimensional model of the power distribution line or the power transmission line and the vegetation. The risk determination method is not limited to the method in the present embodiment and may be another method. Risk determination unit 113 converts the detected area with high risk into geographical information data and provides the geographical information data to database 116.

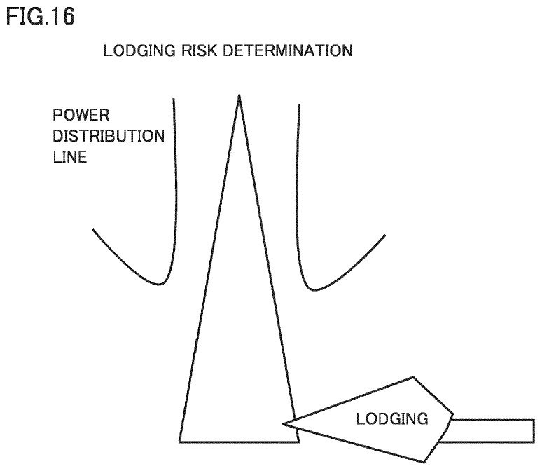

FIG. 16 is a schematic diagram illustrating the lodging risk processing in the risk determination unit in the first embodiment.

In S1006, risk determination unit 113 determines the intrusion risk from the predicted tree crown size and height at the specific time. In this determination, using the predicted tree crown size and height changes and the position relationship with the power distribution line or the power transmission line, a location with high contact possibility is estimated from the size of the tree crown. As an example of a method of the estimation, the intrusion risk is determined taking into consideration the height of the tree and an area occupied by the tree with its crown changed, using the three-dimensional model of the power distribution line or the power transmission line and the vegetation. The risk determination method is not limited to the method in the present embodiment and may be another method. Risk determination unit 113 converts the detected area with high risk into geographical information data and provides the geographical information data to database 116.

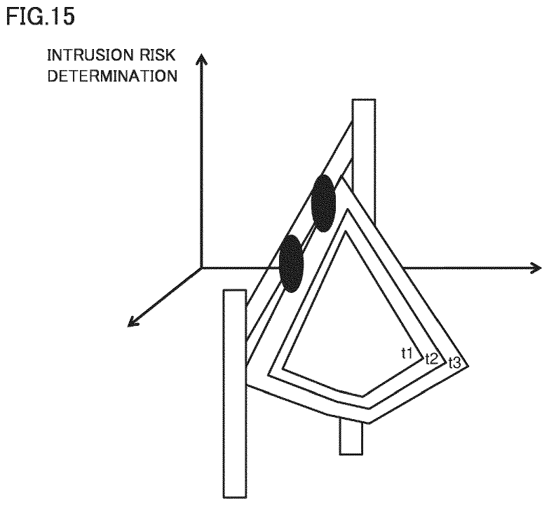

FIG. 15 is a schematic diagram illustrating the intrusion risk processing in the risk determination unit in the first embodiment.

Visualization unit 114 performs processing for visualizing the predicted vegetation tree crown size change and vegetation tree height change and the risk determination result using the prediction result stored in database 116.

Maintenance instruction unit 115 acquires and inputs management information data stored in database 116.

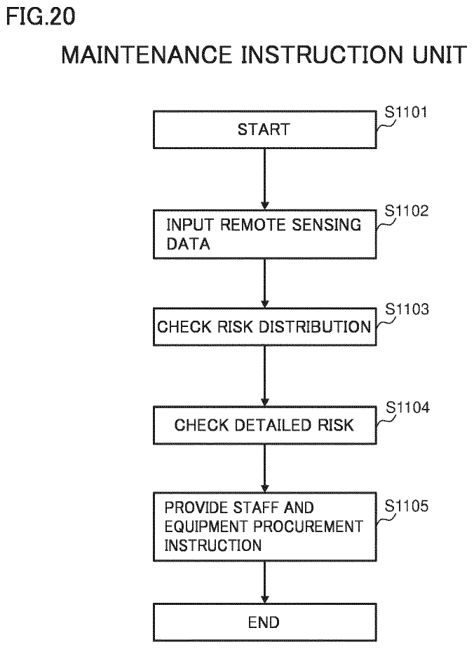

FIG. 20 is a flowchart for explaining processing in the maintenance instruction unit in the first embodiment.

In S1102, maintenance instruction unit 115 inputs the remote sensing data stored in database 116. Examples of the remote sensing data includes a satellite image, a drone image, and an on-board camera image, but the remote sensing image may be other data.

In S1103, maintenance instruction unit 115 checks the risk determination result using the input remote sensing data.

Specifically, maintenance instruction unit 115 checks the distribution of the risk determination result visualized by visualization unit 114 and selects an area of interest. The selection of the area of interest is performed using a threshold on the basis of quantification of risk values, but another method may be used.

In S1104, maintenance instruction unit 115 checks detailed risk for the selected area of interest. A result of the detailed risk determination in the risk determination unit and a result of the detailed risk visualization in the visualization unit are acquired to identify a detailed area. To identify the detailed area, selection is performed using a threshold on the basis of quantification of risk values, but another method may be used.

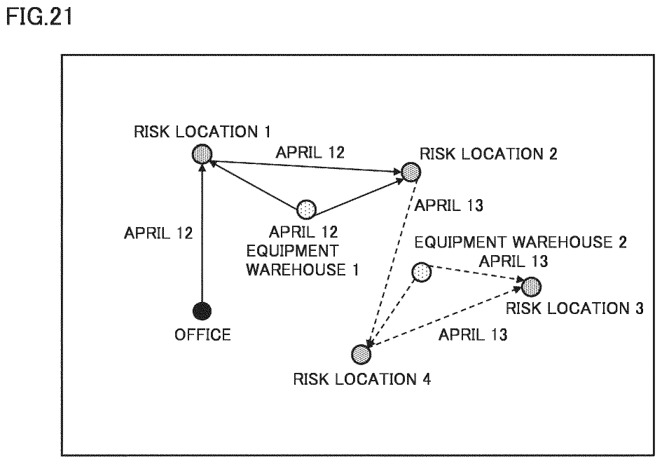

In S1105, maintenance instruction unit 115 acquires the selected detailed area, the contact risk determination result, and the management information data from database 116 and identifies, as a risk location, a location that has high risk and requires maintenance work. Then, the identified risk locations are listed, and routes and times for personnel dispatch and equipment transportation are optimized. FIG. 21 is an example of a maintenance instruction drawing. In the drawing, the locations of an office and two equipment warehouses are shown for four risk locations. Further, a search for an optimum route is performed, a travel time and a working time in a case where the optimum route is employed is calculated to estimate a maintenance time required for maintenance, and route and time instructions are also shown in the drawing. A maintenance instruction screen varies depending on the risk locations, and the locations of the office and equipment warehouses. Also, the degree or type of risk may be used in the search for the optimum route. For example, a search for a route to eliminate the lodging risk with a higher priority can also be performed.

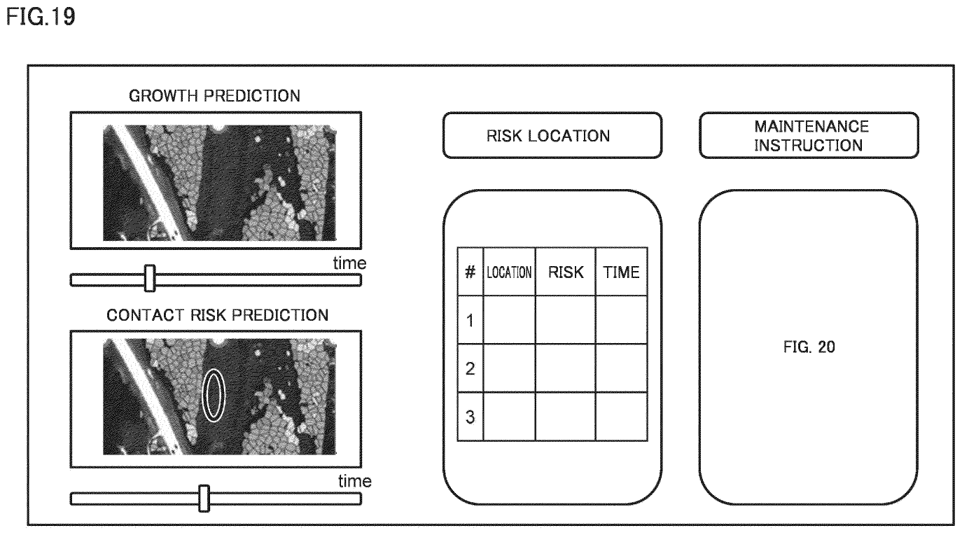

Visualization unit 114 and maintenance instruction unit 115 support maintenance work using display on a management GUI. FIG. 19 is an example of a GUI schematic diagram illustrating the visualization and maintenance instruction in the first embodiment. A screen illustrated in FIG. 19 has display blocks for the tree growth change and the change in the risk of contact with the power facility, and the changes can be visualized by shift on a time axis. Also, the list of risk locations is displayed so that information such as the latitude and longitude, the degree of risk, and a predicted time can be displayed. The maintenance instruction schematic diagram of FIG. 21 is displayed on a maintenance instruction block. Detailed design and detailed items of the GUI may be other design and other items.

As described above, the vegetation management system of the present disclosure is a vegetation management system that manages an influence of vegetation on a predetermined feature, the vegetation management system including: an acquisition unit that acquires remote sensing image data of the vegetation; a classification unit that classifies, based on the remote sensing image data, a tree included in the vegetation in accordance with growth activity representing potential for future growth; a growth prediction unit that predicts growth of the tree based on a classification result obtained by the classification unit; a risk determination unit that determines risk of contact with the predetermined feature; and a visualization unit that outputs and visualizes a determination result obtained by the risk determination unit.

According to the above configuration and operation, it is possible to predict the influence of vegetation on a feature with high accuracy by using the new method of classification by tree growth activity.

In the vegetation management system of the present disclosure, different methods are used in the growth prediction and/or the contact risk determination in accordance with the classification result.

Thus, the growth of vegetation can be predicted with high accuracy by using the methods corresponding to the vegetation growth activity levels in combination.

In the vegetation management system of the present disclosure, the classification result includes a withered tree that is withered and has no future growth, a special growing tree with tree-felling and/or branch removal performed, a fast growing tree evaluated as having high growth activity based on time-series changes in the remote sensing image data, and a slow growing tree evaluated as having low growth activity based on time-series changes in the remote sensing image data.

The growth of vegetation can be predicted efficiently and with high accuracy by performing appropriate classification in this manner.

In the vegetation management system of the present disclosure, for the withered tree, the withered tree is excluded from a prediction target for the growth prediction, and risk determination models for lodging and fly-out are used for the contact risk determination.

In the vegetation management system of the present disclosure, for the fast growing tree and the slow growing tree, growth is predicted, and risk determination models for intrusion and lodging caused by a size change based on the predicted growth are used.

In the vegetation management system of the present disclosure, for the special growing tree, growth is predicted, and a risk determination model for intrusion caused by a size change is used.

The influence of vegetation on a feature can be predicted with high accuracy by performing growth prediction and risk determination in accordance with classification in this manner.

The vegetation management system of the present disclosure further includes: a tree height estimation unit that estimates a tree crown height from a vegetation area in the remote sensing image data; a tree crown extraction unit that extracts a tree crown of the tree in accordance with the tree crown height estimated; and a time-series analysis unit that calculates time-series changes in a size of the tree crown extracted and the tree crown height estimated. The classification unit executes tree classification by the growth activity using the time-series changes.

The growth activity can be obtained using image processing on an image taken from the sky by using the tree crown height and size in this manner.

The vegetation management system of the present disclosure further includes a maintenance instruction unit that formulates and presents a maintenance plan using the growth activity of the tree and a location of the predetermined feature.

In the vegetation management system of the present disclosure, the predetermined feature is a power facility, and the maintenance instruction unit formulates an operation execution route corresponding to growth activity of a surrounding tree for maintenance of base equipment and a power line of the power facility.

Thus, an efficient maintenance plan can be presented on the basis of a highly accurate prediction result of the influence of vegetation.

For example, it is possible to optimize a personnel and equipment introduction route to a mountainous area or a location difficult to access, thereby reducing the maintenance cost.

Note that the present invention is not limited to the embodiment described above and includes various modifications. For example, the above embodiment is described in detail to explain the present invention in an easy-to-understand manner and not necessarily limited to one having all the configurations described above.

In addition, a part of the configuration of one embodiment can be replaced with the configuration of another embodiment, and the configuration of one embodiment can also be added with the configuration of another embodiment.

In addition, a part of the configuration of each embodiment may be added, deleted, or replaced with another configuration.

In addition, each of the configurations, functions, processing units, processing means, and the like described above may be implemented as hardware, for example, by designing some or all of them with an integrated circuit.

In addition, each of the configurations, functions, and the like described above may be implemented as software by a processor interpreting and executing a program that realizes each function.

Information on a program, a table, a file, and the like that achieve each function can be stored in a storage device such as a memory, a hard disk, or a solid state drive (SSD), or a recording medium such as an integrated circuit (IC) card, an SD card, or a digital versatile disc (DVD).

Only control lines and information lines that are considered to be necessary for explanation are illustrated, and not necessarily all the control lines and information lines required for a product are illustrated. In practice, it may be considered that almost all the configurations are connected to each other.

### REFERENCE SIGNS LIST

100: Vegetation management system for power facility maintenance
101: Different input data items
101a: Remote sensing image data
101b: Vegetation information data
101c: Geographical information data
101d: Environment information data
101e: Management information data
102: Remote sensing data acquisition unit
103: Geographical information acquisition unit
104: Environment information acquisition unit
105: Management information acquisition unit
106: Database generation unit
107: Withered tree extraction unit
108: Tree height estimation unit
109: Tree crown extraction unit
110: Time-series analysis unit
111: Vegetation classification unit
112: Growth prediction unit
113: Risk determination unit
114: Visualization unit
115: Maintenance instruction unit
116: Database unit

1. A vegetation management system that manages an influence of vegetation on a predetermined feature, the vegetation management system comprising:
an acquisition unit that acquires remote sensing image data of the vegetation;
a classification unit that classifies, based on the remote sensing image data, a tree included in the vegetation in accordance with growth activity representing potential for future growth;
a growth prediction unit that predicts growth of the tree based on a classification result obtained by the classification unit;
a risk determination unit that determines risk of contact with the predetermined feature; and
a visualization unit that outputs and visualizes a determination result obtained by the risk determination unit.

2. The vegetation management system according to claim 1, wherein
different methods are used in the growth prediction and/or the contact risk determination in accordance with the classification result.

3. The vegetation management system according to claim 1, wherein
the classification result includes a withered tree that is withered and has no future growth, a special growing tree with tree-felling and/or branch removal performed, a fast growing tree evaluated as having high growth activity based on time-series changes in the remote sensing image data, and a slow growing tree evaluated as having low growth activity based on time-series changes in the remote sensing image data.

4. The vegetation management system according to claim 3, wherein
for the withered tree,
the withered tree is excluded from a prediction target for the growth prediction, and
risk determination models for lodging and fly-out are used for the contact risk determination.

5. The vegetation management system according to claim 3, wherein
for the fast growing tree and the slow growing tree,
growth is predicted, and risk determination models for intrusion and lodging caused by a size change based on the predicted growth are used.

6. The vegetation management system according to claim 3, wherein
for the special growing tree,
growth is predicted, and a risk determination model for intrusion caused by a size change is used.

7. The vegetation management system according to claim 1, further comprising:
a tree height estimation unit that estimates a tree crown height from a vegetation area in the remote sensing image data;
a tree crown extraction unit that extracts a tree crown of the tree in accordance with the tree crown height estimated; and
a time-series analysis unit that calculates time-series changes in a size of the tree crown extracted and the tree crown height estimated, wherein
the classification unit executes tree classification by the growth activity using the time-series changes.

8. The vegetation management system according to claim 1, further comprising a maintenance instruction unit that formulates and presents a maintenance plan using the growth activity of the tree and a location of the predetermined feature.

9. The vegetation management system according to claim 8, wherein
the predetermined feature is a power facility, and
the maintenance instruction unit formulates an operation execution route corresponding to growth activity of a surrounding tree for maintenance of base equipment and a power line of the power facility.

10. A vegetation management method performed by a vegetation management system that manages an influence of vegetation on a predetermined feature, the method comprising:
by the vegetation management system,
acquiring remote sensing image data of the vegetation;
classifying, based on the remote sensing image data, a tree included in the vegetation in accordance with growth activity representing potential for future growth;
predicting growth of the tree based on a classification result obtained by the classifying;
determining risk of contact with the predetermined feature; and
outputting and visualizing a determination result obtained by the determining risk.
